(19) United States
(12) Patent Application Publication
(10) Pub. No.: US 2011/0308344 A1
(43) Pub. Date: Dec. 22, 2011

(54) MECHANICAL, MULTI-STEP AUTOMATIC GEARBOX

(75) Inventor: Kyung Yul Hyun, Seoul (KR)

(73) Assignee: UT GLOBAL CO., LTD., Daejeon (KR)

(21) Appl. No.: 13/201,036

(22) PCT Filed: Jul. 29, 2010
(86) PCT No.: PCT/KR2010/004997

§ 371 Date: Aug. 11, 2011

(30) Foreign Application Priority Data
Jul. 31, 2009 (KR) 10-2009-0070784

(51) Int. Cl. F16H 63/30

(52) U.S. Cl. 74/337.5

(57) ABSTRACT

Multiple gear changes can easily be achieved by means of a straightforward and simple mechanical method, power transmission efficiency and the gear-changing sensation can be improved as compared with the prior at, and, in addition, fuel consumption can actually be reduced even as power performance is increased.

### RELATED APPLICATIONS

This application is a 371 application of International Application No. PCT/KR2010/004997, filed Jul. 29, 2010, which in turn claims priority from Korean Patent Application No. 10-2009-0070784, filed Jul. 31, 2009, each of which is incorporated herein by reference in its entirety.

### TECHNICAL FIELD

The present invention relates to a mechanical multi-step automatic gearbox, and in particular to a mechanical multi-step automatic gearbox which makes it possible to achieve a multi-step speed change by an easy and simple mechanical method, thus more enhancing driving force transfer efficiency and a speed change feeling as compared to a conventional gearbox, while improving driving force performance and saving fuel consumption.

### BACKGROUND ART

The multi-step automatic gearbox applied to a vehicle or an industrial machine or something generally is formed of a plurality of satellite gear sets.

The gear train formed of a plurality of satellite gear sets serves to convert an engine torque into multiple stage torques when it is inputted as a rotational driving force from a torque converter and transmits to an output side.

The more the speed change stages are provided, the more advantageous the power train of the automatic gearbox is in terms of their driving force performance and fuel consumption rate. Lots of researches are being conducted on developing a new train serving more speed change stages.

Even when the same speed change stages are implemented, since the durability, driving force transfer efficiency, and size and weight change a lot depending on a combining way of the satellite gear set, it is needed to develop a new gear train serving to minimize the loss in driving force and in compact size.

The development trend of the satellite gear set is focused on how to combine a conventional single pinion satellite gear set and a double pinion satellite gear set and where to arrange clutches and brakes, and how many one direction clutch are arranged at which position, thus implementing a gearbox performance along with a desired speed change stage without loss in a driving force and a gearbox ratio.

Meanwhile in case of the manual gearbox, when there are too many speed change stages, it is needed for a driver to change gearbox more, which causes inconveniences.

In case of the automatic gearbox, a computer gearbox control unit (CJU) serves to automatically control the operations of the gear train depending on a driving state, so it is considered very valuable to develop a gear train serving more speed change stages.

Various researches are under development on the basis of above demands. A gear train with an automatic speed change stage with a forward 6-times speed and a forward 8-times sped is proposed.

The applicant of the present invention has proposed a new type mechanical multi-step automatic gearbox, in a mechanical type, serving to easily perform a forward 8-times speed or more or fewer speed change stages and to enhance, as compared to a conventional art, a driving force gearbox efficiency and a gearbox feeling with the aid of a good combination of an organic mechanism in the operation of speed change stages, while increasing a driving force performance and saving a fuel consumption.

### DISCLOSURE OF INVENTION

Accordingly it is an object of the present invention to provide a new type multi-step automatic gearbox which makes it possible to achieve a multi-step speed change by an easy and simple mechanical method, thus more enhancing driving force transfer efficiency and a speed change feeling as compared to a conventional gearbox, while improving driving force performance and saving fuel consumption.

To achieve the above objects, there is provided a mechanical multi-step automatic gearbox, comprising a housing which forms an outer appearance; an input side shaft which is engaged to one side of the housing and rotates by means of an engine torque; a plurality of input side driving gears which are fixed in a pyramid shape at an outer side of the radius direction of the input side shaft and rotates along with the input side shaft, with one direction clutch being disposed between the input side shaft and the input side driving gear; a plurality o output side driven gears which are tooth-engaged, in reverse directions, with the plurality of the input side driving gears in a pyramid shape and have a non-circular cam space in its interior; an output side shaft of which one region is arranged in the cam space of the output side driven gears exposed to the outside of the housing, and the remaining regions are exposed to the outside of the housing; a plurality of tactical pressurization members which are movably engaged to the output side shaft and move to the outer side of the radius direction of the output side shaft by means of a centrifugal force generating during the rotation and selectively come into contact with the inner surface of the output side driven gears and are pressurized; and a support unit which is engaged to the interior of the output side shaft and supports a corresponding tactical pressurization member which comes into contact with an inner surface of at least one output side driven gear of the tactical pressurizing members and is pressurized.

Here, the support unit comprises a screw shaft having one region arranged in the interior of the output side shaft and the remaining regions exposed to the outside of the housing; and a loader which is screw-engaged to the screw shaft for a movement along the screw shaft during the rotation of the screw shaft and supports a corresponding tactical pressurization member.

Here, the loader comprises a cylindrical support part for supporting the corresponding tactical pressurization member; and a pair of inclined parts each getting gradually smaller in their diameter sizes than the cross section diameter of the cylindrical support part in a direction from the both ends of the cylindrical support part to the outside.

A plurality of bearings are disposed at an outer surface of the cylindrical support part.

The support unit comprises a pair of shaft support member which are engaged with the both sides of the screw shaft about the loader and are fixed at the housing.

The support unit comprises a plurality of guide members which are connected with the pair of the shaft support members and guide the movements of the loader for the loader to reciprocate along the screw shaft.

The tactical pressurization members each comprise a piston, and a friction member which is connected to the piston and operates by means of the piston and selectively comes into contact with the inner surface of the output side driven gear and is pressurized.

The friction members are disposed at regular intervals along the circumferential directions in the cam space and each are formed in an arc type block shape or a ball shape.

A combination of the plurality of the input side driving gears and the plurality of the output side driven gears is formed of one backward movement stage and neutral stage and ten forward movement speed change stages, respectively.

### Effects of the Invention

According to the present invention, there is provided a new type multi-step automatic gearbox which makes it possible to achieve a multi-step speed change by an easy and simple mechanical method, thus more enhancing driving force transfer efficiency and a speed change feeling as compared to a conventional gearbox, while improving driving force performance and saving fuel consumption.

### BRIEF DESCRIPTION OF THE DRAWINGS

The present invention will become better understood with reference to the accompanying drawings which are given only by way of illustration and thus are not limitative of the present invention, wherein;

FIG. 1 is a schematic view of a mechanical multi-step automatic gearbox according to a first embodiment of the present invention and shows a construction that a loader is arranged at a sixth stage speed change part;

FIG. 2 is a view of a construction tat a loader is arranged at a natural stage in a mechanical multi-step automatic gearbox of FIG. 1;

FIG. 3 is a perspective view of a support unit;

FIG. 4 is a partial disassembled perspective view of FIG. 3;

FIG. 5 is a view of an arrangement between an output side driven gear and an input side driving gear depending on the operations of a friction member, a piston and a loader;

FIG. 6 is a schematic view of a mechanical multi-step automatic gearbox according to a second embodiment of the present invention;

FIG. 7 is a view of an arrangement between an output side driven gear and an input side driving gear depending on the operations of a friction member, a piston and a loader in a mechanical multi-step automatic gearbox according to a third embodiment of the present invention;

FIG. 8 is a view of an arrangement between an output side driven gear and an input side driving gear depending on the operations of a friction member, a piston and a loader in a mechanical multi-step automatic gearbox according to a fourth embodiment of the present invention;

FIG. 9 is a view of an arrangement between an output side driven gear and an input side driving gear depending on the operations of a friction member, a piston and a loader in a mechanical multi-step automatic gearbox according to a fifth embodiment of the present invention; and

FIG. 10 is a view of an arrangement between an output side driven gear and an input side driving gear depending on the operations of a friction member, a piston and a loader in a mechanical multi-step automatic gearbox according to a sixth embodiment of the present invention.

### MODES FOR CARRYING OUT THE INVENTION

The preferred embodiments of the present invention will be described with reference to the accompanying drawings. The same constructions in the course of describing the embodiments will be given the same reference numerals. What the multi-step automatic gearbox is applied to a vehicle will be described as an example of the present invention.

The preferred embodiments of the present invention will be described in such a manner that the same constructions in the course of the descriptions will be given the same reference numerals.

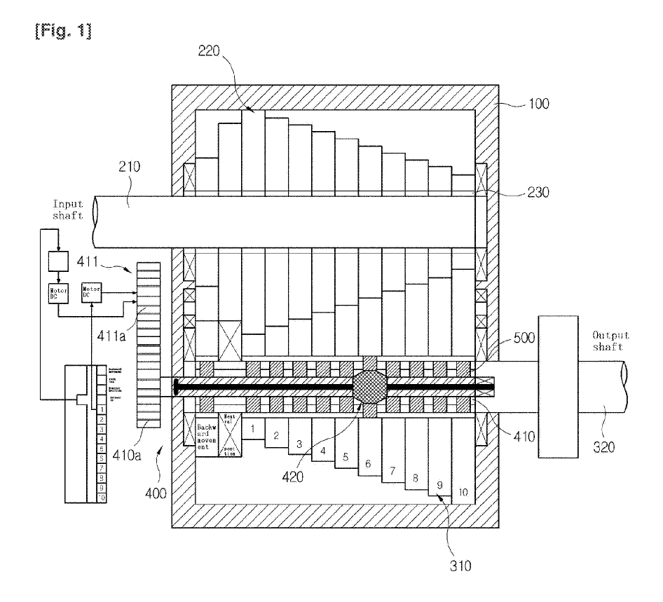

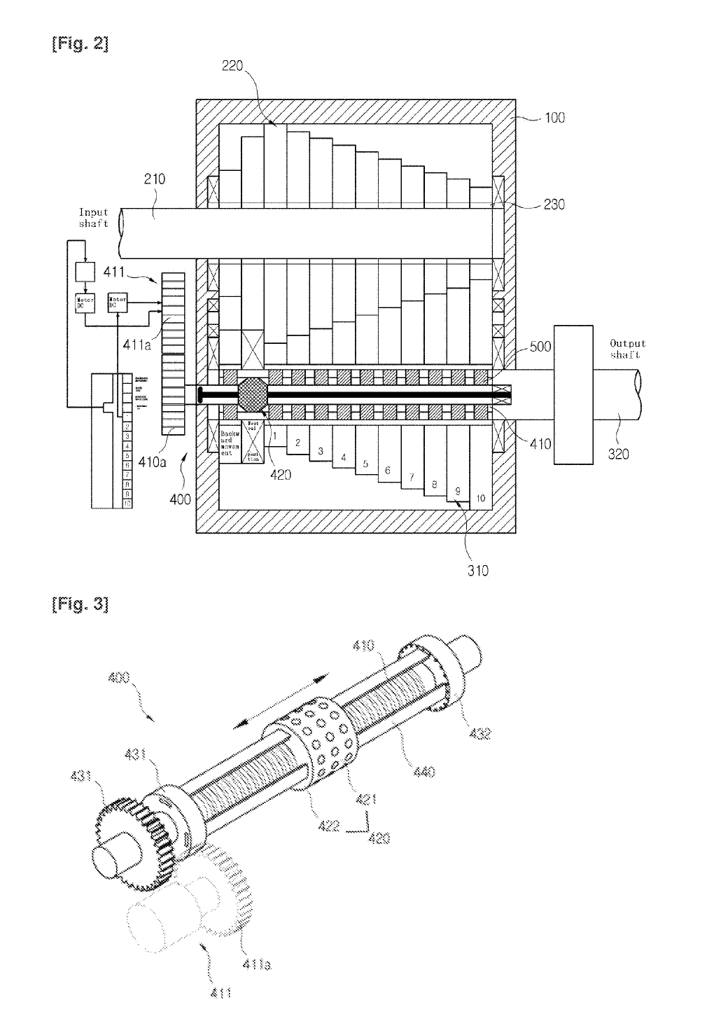

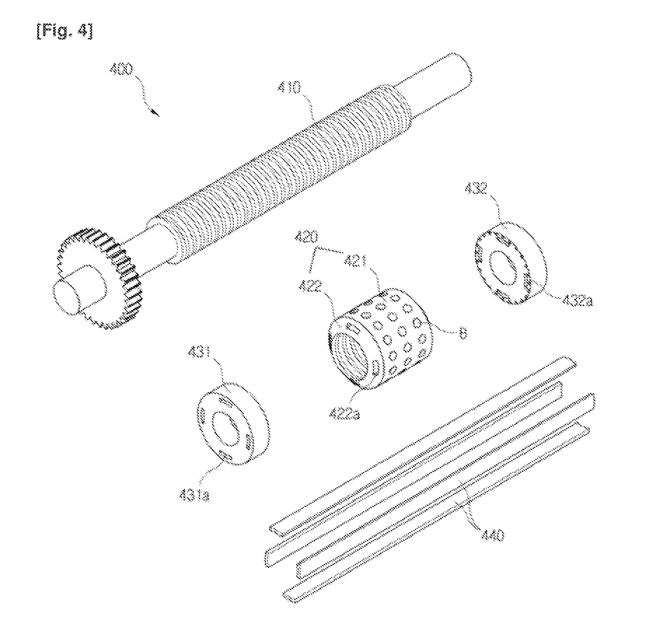

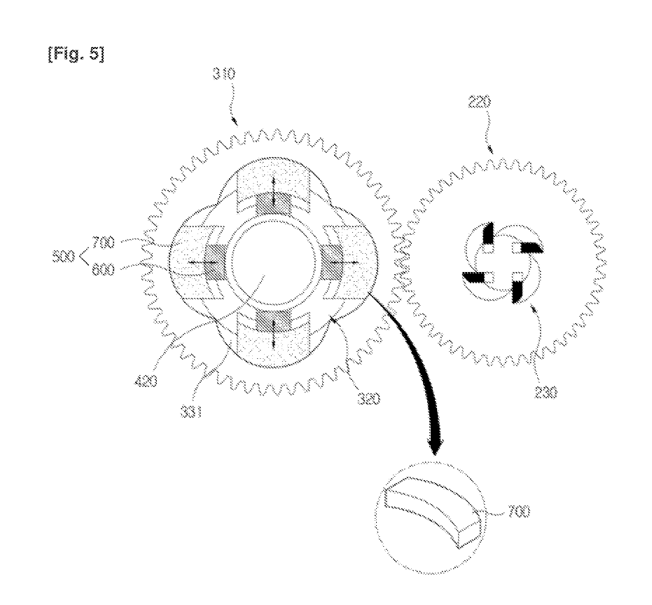

FIG. 1 is a schematic view of a mechanical multi-step automatic gearbox according to a first embodiment of the present invention and shows a construction that a loader is arranged at a sixth stage speed change part, FIG. 2 is a view of a construction tat a loader is arranged at a natural stage in a mechanical multi-step automatic gearbox of FIG. 1, FIG. 3 is a perspective view of a support unit, FIG. 4 is a partial disassembled perspective view of FIG. 3, and FIG. 5 is a view of an arrangement between an output side driven gear and an input side driving gear depending on the operations of a friction member, a piston and a loader.

As shown in FIG. 1, the mechanical multi-step automatic gearbox according to the embodiment of the present invention comprises a housing 100, an input e shaft 210 and an input side driving gear 220 as an input side construction, an output side driven gear 310 and an output side shaft 320 as an output side construction, a plurality of tactical type pressurization member 500 movably engaged to the output side shaft 300, a support unit 400 which is engaged in the interior of the output side shaft 320 and supports a corresponding tactical pressurization member 500 tactically pressurized by an inner surface of one output side driven gear 310 among the tactical pressurization members 500, and a control part (not shown) organically controlling the above elements.

First of all, the housing 100 forms an outer appearance of the mechanical multi-step automatic gearbox according to the present invention. The housing 100 is made of a strong metallic material. Most of the elements are accommodated in the housing 100 and are assembled.

One region of the input side shaft 210 and one region of the output side shaft 320 are exposed partially from the outside of the housing 100 when in operation.

Bearings are disposed between the input side shaft 210 and the housing 100, and the output side shaft 320 and the housing 100 for smooth rotations. A packing (not shown) is disposed between the same. For convenience, the bearings and the packing are not shown in the drawings.

The input side shaft 210 is an element rotating by engine torque, namely, diving force is inputted into the input side shaft 210 for vehicle driving. The inputted driving force is decreased or increased by means of the output side shaft 320 by means of the structure which will be described layer and then outputted. The decrease and increase include speed and torque.

The input side driving gear 220 is fixed at the radius direction outer side of the input side shaft 210 in a pyramid shape and rotates together with the input side shaft 210.

The input side driving gear 220 is engaged with the input side shaft 210 by means of one direction clutch 230 (FIGS. 1 and 2 and 5) for the input side driving gear 220 to rotate along with the input side shaft 210. The one direction clutch 230 might not be used, and the input side driving gear 220 might be integrated with the input side shaft 210 instead.

The mechanical multi-step automatic gearbox according to the embodiment of the present invention is directed to that it has one backward movement stage, one neutral stage and ten forward movement speed change stages, so the input side driving gear 220 in the pyramid shape is manufactured corresponding thereto.

The above construction is just one embodiment. Namely, the mechanical multi-step automatic gearbox according to the embodiment of the present invention might have more or fewer than ten forward movement speed change stages. In this case, the input side driving gear 220 and the output side driven gear 310 can be formed of a proper number of stages corresponding thereto.

For the purposes of illustrations and descriptions, the position-based drawing reference numerals of the input side driving gear 220 and the output side driven gear 310 are not separated, and the characters and numbers are given in the drawings instead.

The output side driven gear 310 is formed in the pyramid shape like the input side driving gear 220, but it is arranged reverse to the input side driving gear 220, so the output side driven gear 310 is tooth-engaged with the input side driving gear 220 in the reverse direction one by one. The inner space of the output side driven gear 310 forms a non-circular cam space 331 (FIG. 5).

In the output side shaft 320, one region is arranged in the cam space 331 of the output side driven gear 310 in the housing 100, and the remaining regions are exposed to the outside o the housing 100.

In the present embodiment, the output side shaft 320 is separated from the output side driven gear 310, so even when the output side driven gear 310 rotates, the output side shaft 320 rotates idle in a slip friction state.

The output side shaft 320 comes into contact with one of the output side driven gears 310 and is pressurized by the structure and operation, which will be described later, and forms one body, so the output side shaft 320 rotates.

For the above operations, in other words, there are provided a plurality of tactical pressurization members 500 and a support unit 400 so that the output side shaft 320 comes into contact with one of the output side driven gears 310 and is pressurized, thus forming one body.

The plurality of the tactical pressurization members 500 are movably engaged to the output side shaft 320, namely, as shown in FIG. 5, a plurality of tactical pressurization members 500 formed of the piston 600 and the friction member 700 are movably engaged to the output side shaft 320. The tactical pressurization members 500 move toward the outer side of the radius direction of the output side shaft 320 by means of the centrifugal force generating in the course of rotation and selectively come into tactical contact with the inner surfaces of the output side driven gars 310 and are pressurized.

Here the plurality of the friction members 700 are connected with the plurality of the pistons 600 and become movable toward the inner side or outer side in the radius directions along with a corresponding piston 600. The friction member 700 is provided corresponding to the piston 600 one by one. The friction member 700 of the present invention has an arc shaped block structure and can be engaged to or disengaged from the friction member groove (not shown) formed at the output side shaft 320. In the present embodiment of the present invention, four friction members 700 are arranged at intervals along the circumferential direction. It is obvious that the scope of the present invention is not limited to the disclosed drawings.

The tactical pressurization member 500, particularly, the friction member 700 of the tactical pressurization member 500 moves toward the inner surfaces of the output side driven gears 310 by means of the centrifugal force generating in the course of rotation or comes into contact with the inner surfaces of the output side driven gears 310, but their forces are not strong, so it is almost impossible for the output side driven gears 310 and the output side shaft 320 to become integral.

However when there is little force for supporting the tactical pressurization member 500 contacting with the inner surfaces of the output side driven gear 310, the tactical pressurization member 500 is not pushed by such force, but in that state it can come into contact with the inner surface of a corresponding output side driven gear 310 and can be pressurized. So, in this state, the output side driven gear 310 and the output side shaft 320 become one body, so the output side shaft 320 can rotate, the operations of which are conducted by means of the support unit 400.

In other words, the support unit 400 serves to support a corresponding tactical pressurization member 500 having come into contact with the inner surface of one output side driven gear 310 among the plurality of the tactical pressurization members 400 engaged in the interior of the output side shaft 320 and having pressurized. As shown in FIG. 1, the support unit 400 supports the tactical pressurization member 500 at the sixth-stage speed change stage. In this case, the vehicle can be speed-changed to the sixth stage.

As shown in FIGS. 3 and 4, the support unit 500 performing the above operations comprises s screw shaft 410, a loader 420 which supports a corresponding tactical pressurization member 500 rotatably engaged to the screw shaft 410 movably along the screw shaft 410 when the screw shaft 410 rotates, namely, supports the tactical pressurization member 500 positioned at the sixth-stage speed change stage as shown in FIG. 1, a pair of shaft support members 431 and 432 engaged to both sides of the screw shaft 410 about the loader 420, and a plurality of guide members 440 which are connected to the loader 420 and the pair of the shaft support members 431 and 432 thus guiding the movements of the loader 420.

As shown in FIGS. 1 and 2, the screw shaft 410 is configured in such a manner that its one region is arranged in the interior of the output side shaft 320 and the remaining regions are exposed to the outside of the housing 100. The rotation driving force of the screw shaft 410 is transferred, by the driving force transfer part 411, to the gears or pulleys provided at the outer side of the housing 100. The gears 411a of the driving force transfer part 411 are tooth-engaged with the gear 410a of the screw shaft 410, thus rotating the screw shaft 410.

The loader 420 comprises a cylindrical support part 421 supporting a corresponding tactical pressurization member 500, namely, a tactical pressurization member 500 positioned at the sixth stage speed change stage of FIG. 1, and a pair of inclined parts 422 getting smaller than the cross section diameters of the cylindrical support part 421 in the direction from the both ends of the cylindrical support part 421 to the outer side. With the aid of the pair of the inclined parts 422, the loader 420 can move smoothly without any interference with other tactical pressurization member 500 when moving along the screw shaft 410. A plurality of bearings B are disposed at an outer surface of the cylindrical support part 421.

The loader 420 is screw-engaged to the screw shaft 410, and the pair of the shaft support members 431 and 432 are fixed at the housing 100, and the pair of the shaft support members 431 and 432 and the loader 420 are interconnected by means of a plurality of the guide members 440, so when the screw shaft 410 rotates in the normal or reverse direction, the loader 420 thereby reciprocates along the longitudinal direction of the screw shaft 410.

The pair of the shaft support members 431 and 432 serve to support the plurality of the guide members 440 as well as the screw shaft 410. As shown in FIGS. 1 and 2, the shaft support members 431 and 432 are fixed at the housing 100. Even when the screw 410 rotates, the pair of the shaft support members 431 and 432 don't rotate. One of the pair of the shaft support members 431 and 432 can be configured to freely rotate.

The plurality of the guide members 440 serve to guide the movements of the loader 420 reciprocating along the screw shaft 410. In the present embodiments, the plurality of the guide members 440 are formed of four arc shaped bars which pass through the holes 422a formed at the inclined part 422 of the loader 420, the both ends of each of which are inserted into the grooves 431a and 432a of the pair of the shaft support members 431 and 432. The above constructions are not limited thereto. The numbers and the shapes of the guide members 440 might be changed.

In the above construction, when the gear 411a of the driving force transfer part 411 rotates, the gear 410a of the screw shaft 410 engaged thereto rotates therewith as well, so the screw shaft 410 rotates. The screw shaft 410 of the support unit 400 rotates, and the loader 420 rotatably engaged to the screw shaft 410 can be positioned at a certain position. In case of the present embodiment of the present invention, it can be positioned at the portion of the sixth-stage speed change stage as shown in FIG. 1.

When the loader 420 is positioned at the portion of the sixth-stage speed change stage, the cylindrical support part 421 of the loader 420 pushes the piston 600, and the friction member 700 connected with the piston 600 is comes into close contact with the inner surface of the output side driven gear 310 positioned at the portion of the sixth-stage speed change stage and is pressurized, so the input side and the output side are tooth-engaged with each other, thus transferring driving force.

The screw shaft 410 is fixed with the gear, and the pair of the shat support members 431 and 432 are fixed at the housing 100, so even when the output side shaft 320 rotates, the loader 420 does not rotate therewith. When the output side shaft 320 rotates, the remaining pistons 600 and the friction member 700 come into close contact with the inner surface of the output side driven gear 310, but do not affect the transfer of driving force due to the slip phenomenon.

In the above state, when the fourth-stage speed change is needed, the screw shaft 410 is rotated by the gears, and the loader 420 is positioned at the fourth-stage speed change stage by means of the screw shaft 410, thus supporting the piston 600 positioned at the fourth-stage speed change stage. The remaining pistons 600 except for the fourth-stage speed change stage are not supported by the loader 420, the speed change stages belonging to the remaining pistons 600 slip and rotate idle.

For reference, FIG. 2 shows a state that the loader 420 is positioned at the neutral position. As shown in FIG. 2, there are not force supporting the pistons 600 positioned at all the speed change stages from the first stage to the tenth stage, all the speed change stages from the first stage to the tent stage slip and rotate idle.

As shown in FIG. 2, the screw shaft 410 should rotate so that the loader 420 keeps reciprocating smoothly, and in the case of stop, as shown in FIG. 2, the loader 420 should be positioned at the neutral position. In other words, when the brake is applied during the operation, the loader 420 positioned at the load stage should be returned to the neutral stage. When the brake is eliminated, the stage should be moved from the neutral stage to the selected speed change stage.

According to the embodiments of the present invention, it is possible to achieve a multi-step speed change by an easy and simple mechanical method, thus more enhancing driving force transfer efficiency and a speed change feeling as compared to a conventional gearbox, while improving driving force performance and saving fuel consumption.

FIG. 6 is a schematic view of a mechanical multi-step automatic gearbox according to a second embodiment of the present invention.

As shown therein, the third and fourth speed stages are engaged concurrently by the loader 420a. The higher stage rotates with load, and the lower stage rotates idle by means of a slip of the one direction clutch 230 based on the circle circumference ratios of the input side and the output side.

As effects, when two stages are concurrently tooth-engaged, one side of the same receives a driving force, but the speed changes are performed without disconnections, thus releasing the impacts and enhancing efficiency. For reference, the clutch is engaged at the input shaft, but in the present invention the clutch is engaged at the output side. The position of the cutch is no limited to the disclosed positions, so it might be installed at the input side.

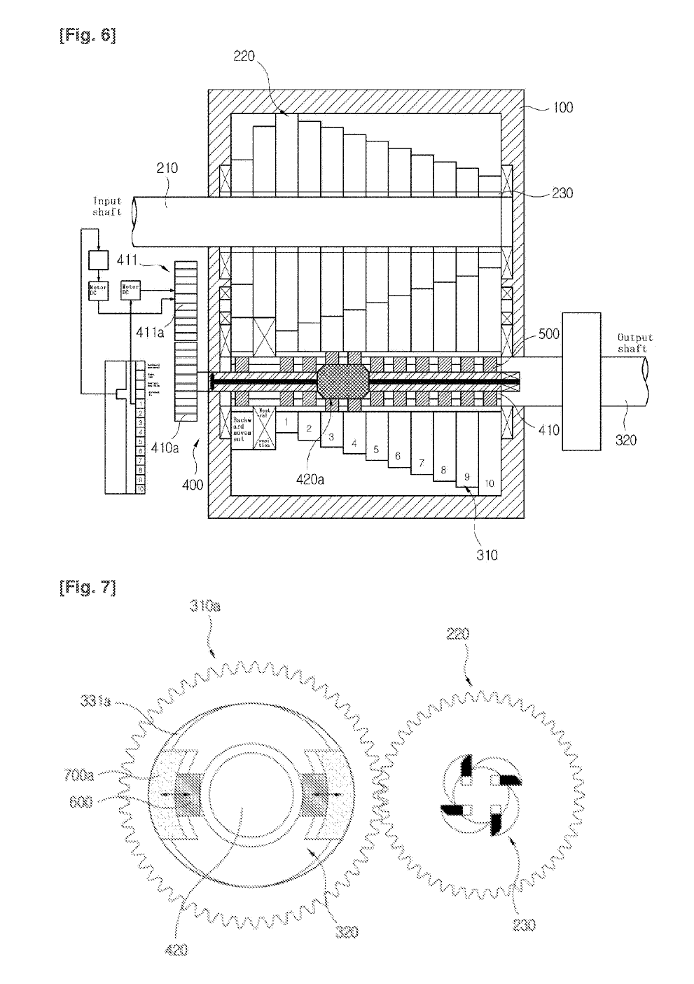

FIGS. 7 to 10 are views of an arrangement between the output side driven gear and the input side driving gear depending on the operations between the friction member, the pistons and the loader in the mechanical multi-step automatic gearbox according to the third to fifth embodiments of the present invention.

As shown in FIG. 7, differently from the first embodiment, two friction members 700a are provided along the circumferential direction. In this case, the inner space structure of the output side driven gear 310a is a little different, but the remaining constructions and operations are same as the first embodiment of the present invention.

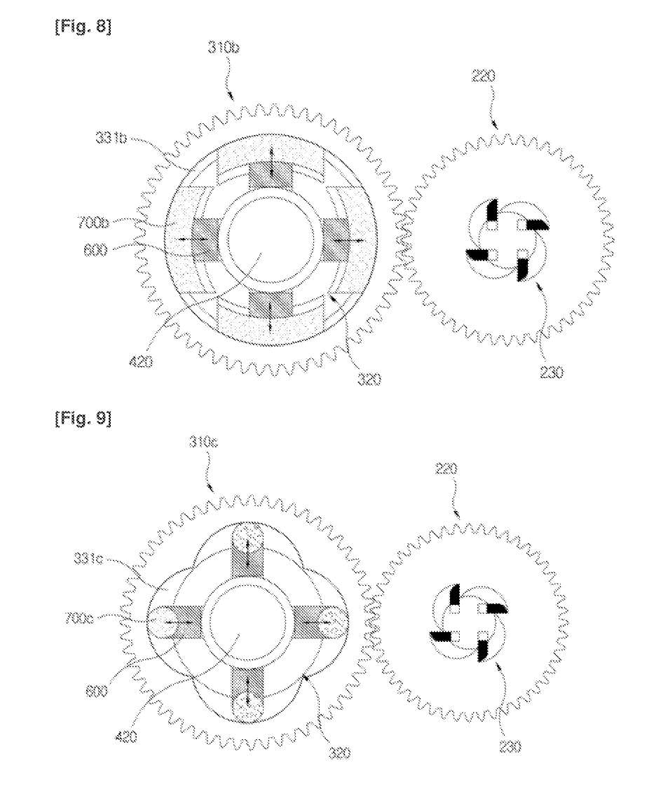

As shown in FIG. 8, four friction members 700b are provide along the circumferential direction, the construction of which is same as the first embodiment, but there is difference in that the inner space structure of the output side driven gear 310b is circular as compared to the first embodiment, however, even when the structure of FIG. 8 is applied, there will be no problems with achieving the effects of the present invention.

As shown in FIG. 9, the friction member 700c is formed not in an arc shaped block structure, but in a ball structure. In this case, the inner space structure of the output side driven gear 310c is a little different, but the remaining constructions and operations are same as the first embodiment of the present invention.

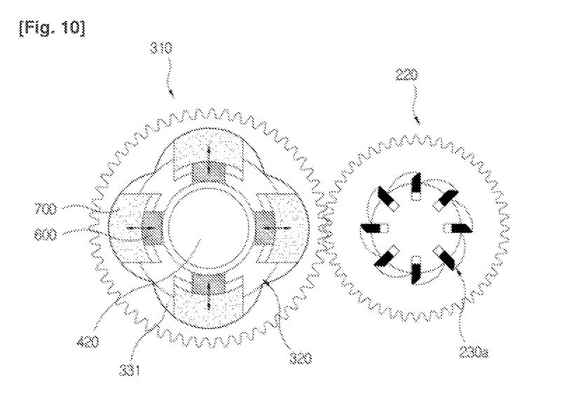

As shown in FIG. 10, the construction of the output side driven gear 310 is same as the first embodiment, but in case of the embodiment of FIG. 10, the structure of the one direction clutch 230a in the input side driving gear 220 is different from the previous embodiments of the present invention.

In the previous embodiments, the descriptions have been omitted, but the mechanical multi-step automatic gearbox according to the present invention can be well applied to common cars and vehicles as well as heavy equipment vehicles.

In the drawings of the previous embodiments, the output side shafts are formed in a rod or pipe shape in parallel, but it can be formed in a pyramid shape.

In the previous embodiments, the descriptions have been omitted, but the mechanical multi-step automatic gearbox according to the present invention can be well applied to common cars and vehicles, heavy equipment vehicles as well industrial purpose machines.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. A mechanical multi-step automatic gearbox, comprising:
a housing which forms an outer appearance;
an input side shaft which is engaged to one side of the housing and rotates by means of an engine torque;
a plurality of input side driving gears which are fixed in a pyramid shape at an outer side of the radius direction of the input side shaft and rotates along with the input side shaft, with one direction clutch being disposed between the input side shaft and the input side driving gear;
a plurality of output side driven gears which are tooth-engaged, in reverse directions, with the plurality of the input side driving gears in a pyramid shape and have a non-circular cam space in its interior;
an output side shaft of which one region is arranged in the cam space of the output side driven gears exposed to the outside of the housing, and the remaining regions are exposed to the outside of the housing;
a plurality of tactical pressurization members which are movably engaged to the output side shaft and move to the outer side of the radius direction of the output side shaft by means of a centrifugal force generating during the rotation and selectively come into contact with the inner surface of the output side driven gears and are pressurized; and
a support unit which is engaged to the interior of the output side shaft and supports a corresponding tactical pressurization member which comes into contact with an inner surface of at least one output side driven gear of the tactical pressurizing members and is pressurized.

2. The mechanical multi-step automatic gearbox according to claim 1, wherein said support unit comprises a screw shaft having one region arranged in the interior of the output side shaft and the remaining regions exposed to the outside of the housing; and a loader which is screw-engaged to the screw shaft for a movement along the screw shaft during the rotation of the screw shaft and supports a corresponding tactical pressurization member.

3. The mechanical multi-step automatic gearbox according to claim 2, wherein said loader comprises a cylindrical support part for supporting the corresponding tactical pressurization member; and a pair of inclined parts each getting gradually smaller in their diameter sizes than the cross section diameter of the cylindrical support part in a direction from the both ends of the cylindrical support part to the outside.

4. The mechanical multi-step automatic gearbox according to claim 3, wherein a plurality of bearings are disposed at an outer surface of the cylindrical support part.

5. The mechanical multi-step automatic gearbox according to claim 3, wherein said support unit comprises a pair of shaft support member which are engaged with the both sides of the screw shaft about the loader and are fixed at the housing.

6. The mechanical multi-step automatic gearbox according to claim 5, wherein said support unit comprises a plurality of guide members which are connected with the pair of the shaft support members and guide the movements of the loader for the loader to reciprocate along the screw shaft.

7. The mechanical multi-step automatic gearbox according to claim 1, wherein said tactical pressurization members each comprise a piston, and a friction member which is connected to the piston and operates by means of the piston and selectively comes into contact with the inner surface of the output side driven gear and is pressurized.

8. The mechanical multi-step automatic gearbox according to claim 7, wherein said friction members are disposed at regular intervals along the circumferential directions in the cam space and each are formed in an arc type block shape or a ball shape.

9. The mechanical multi-step automatic gearbox according to claim 1, wherein a combination of the plurality of the input side driving gears and the plurality of the output side driven gears is formed of one backward movement stage and neutral stage and ten forward movement speed change stages, respectively.
